(19) United States
(12) Patent Application Publication
(10) Pub. No.: US 2017/0144236 A1
(43) Pub. Date: May 25, 2017

(54) Sliding Compound Miter Saw

(71) Applicant: Black & Decker Inc., New Britain, CT (US)

(72) Inventors: Matteo Mortaro, Marsciano (IT); Lucio Ginocchini, San Sisto (IT); Marcello Bettacchini, Ellera di Corciano (IT)

(21) Appl. No.: 15/333,485

(22) Filed: Oct. 25, 2016

(30) Foreign Application Priority Data
Nov. 19, 2015 (GB) 1520416.7
Nov. 19, 2015 (GB) 1520422.5
Nov. 19, 2015 (GB) 1520423.3

(51) Int. Cl. B23D 45/04; B23D 47/02

(52) U.S. Cl. CPC B23D 45/048; B23D 47/02

(57) ABSTRACT

A sliding compound miter saw with a base assembly, a rotatable table pivotally mounted to the base assembly, a mount pivotally mounted on the rear of the rotatable table, a mount base pivotally mounted on the mount to enable the saw to perform chop cuts, and two parallel guide rods rigidly attached to the mount base. The guide rods extend across the base assembly, with one guide rod being located above the other guide rod. A cutting unit is slideably mounted on the two guide rods. A handle is mounted to each side of the base. The handles have top surfaces which are flat and co-planar with the base assembly and/or the rotatable table.

### FIELD OF THE INVENTION

The present invention relates to a sliding compound miter saw.

### BACKGROUND

EP2689878 describes a sliding compound miter saw. Such saws comprise a cutting unit movably mounted on a base assembly. An electric motor is mounted in the cutting unit which is capable of rotationally driving as cutting blade mounted on a spindle which projects from the cutting unit. A sliding compound miter saw can perform chop cuts, bevel cuts, miter cuts and sliding cuts on work pieces located on the base assembly.

### BRIEF DESCRIPTION OF THE DRAWINGS

FIG. 1 shows a perspective view of a miter saw;

FIG. 2 shows an exploded view of the pivot joint of the miter saw from a first perspective;

FIG. 3 shows an exploded view of the pivot joint from a second perspective;

FIG. 4 shows an exploded view of the spring and cup shaped section;

FIG. 5 shows a schematic diagram of a cross sectional view of the pivot joint;

FIG. 6 shows a side view of the guide rods in the cutting unit;

FIG. 7 shows the motor mount with slide bearings;

FIG. 8 shows an exploded view of the motor mount with slide bearings;

FIG. 9 shows an alternative design for the guide rods;

FIG. 10 shows the guide rods of FIG. 10;

FIG. 11 shows a top view of the side handle;

FIG. 12 shows an underside view of the side handle;

FIG. 13 shows an exploded view of the side handle; and

FIG. 14 shows a schematic diagram of the handle attached to the base in the direction of Arrows W in FIG. 11.

### DETAILED DESCRIPTION

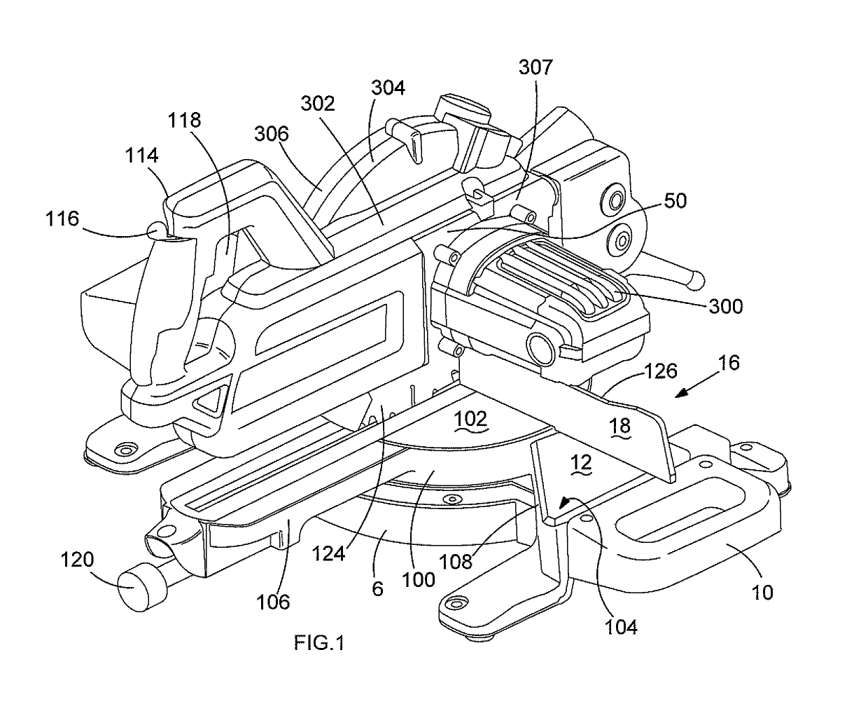

Referring to FIG. 1, the miter saw preferably includes a base assembly comprising a base 6 and a rotatable table 100. The base 6 may have two platforms 12 formed symmetrically on either side of the base 6.

Rotatable table 100 may be rotatably mounted on the base 6 between the two platforms 12. Preferably, the top surface 102 of rotatable table 100 is flat and lies flush with the flat top surfaces 104 of the two platforms 12. The combined surfaces 102, 104 of the platforms 12 and rotatable table 100 preferably form a work surface.

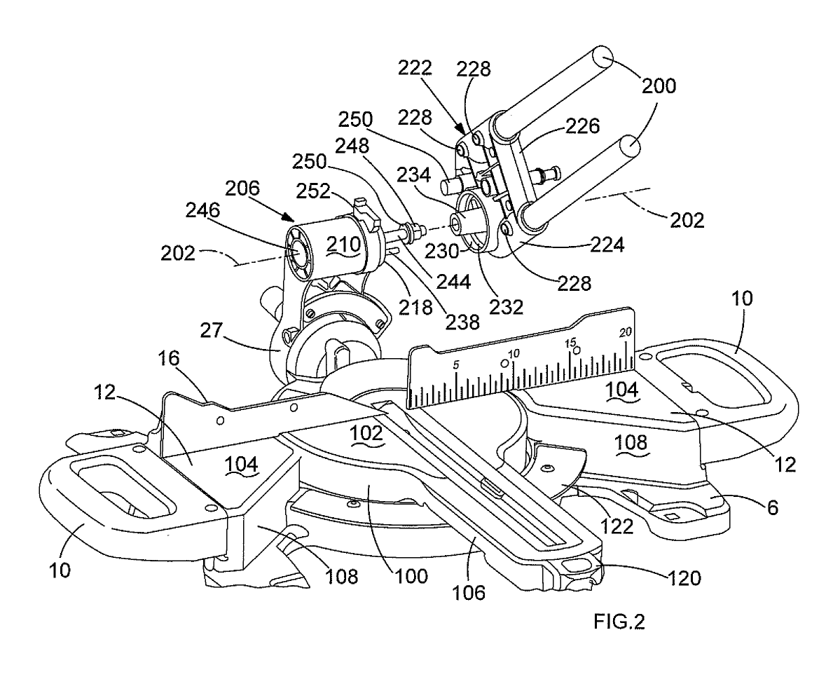

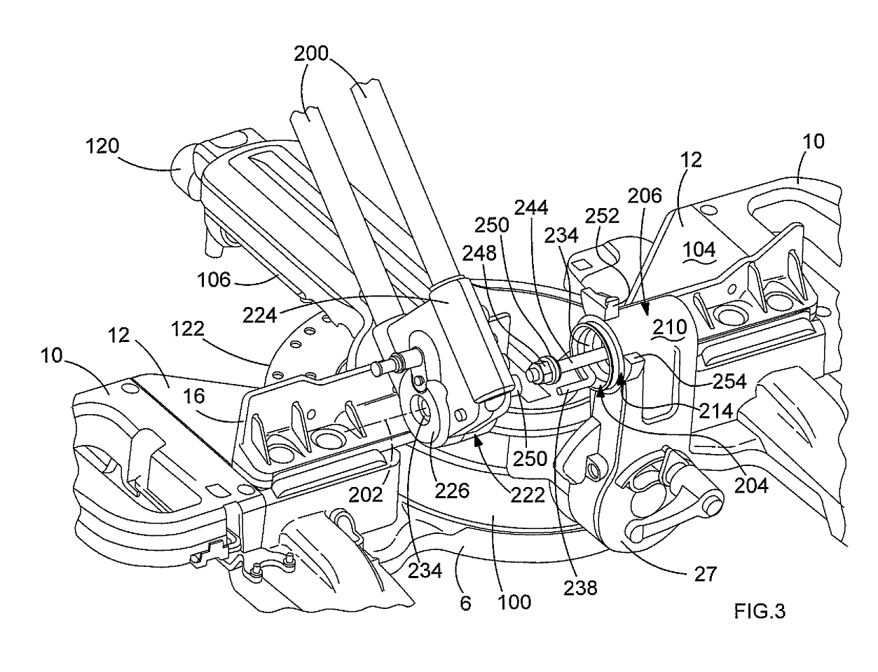

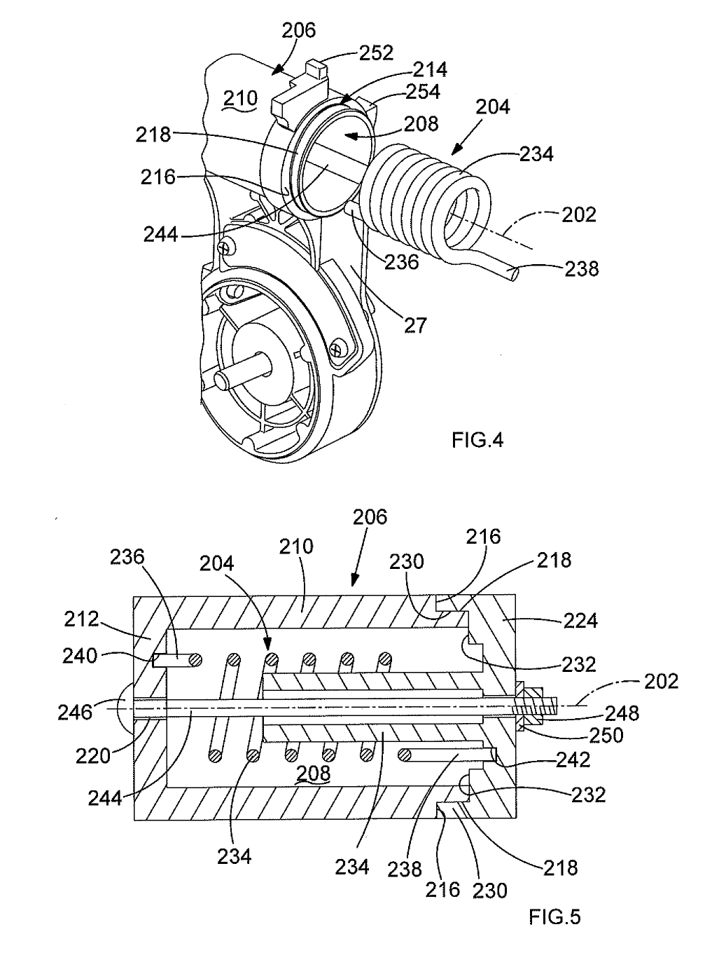

An extension arm 106 may be rigidly attached to the rotatable table 100 and extends forwardly. The rotatable table 100 and extension arm 106 can pivot about a vertical axis through a range of angular positions. The angular movement may be restricted by the extension arm 106 engaging with one or other of the sides 108 of the platforms 12. A locking lever 120 can be used to lock the rotatable table 100 and extension arm 106 in desired angular positions. A scale 122 (shown in FIGS. 2 to 4) is attached to the base 6 to indicate the angular position of the extension arm 106.

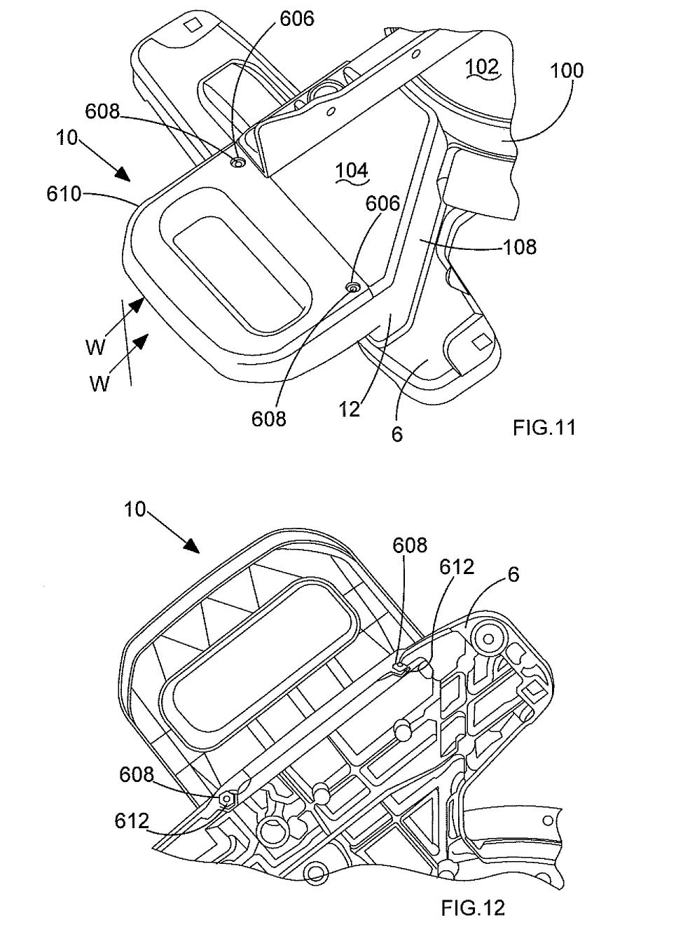

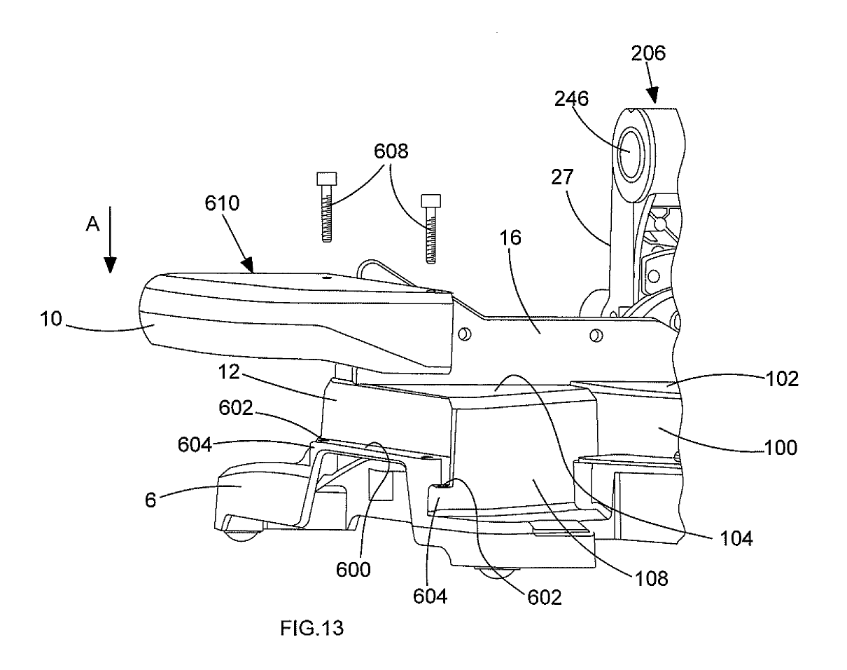

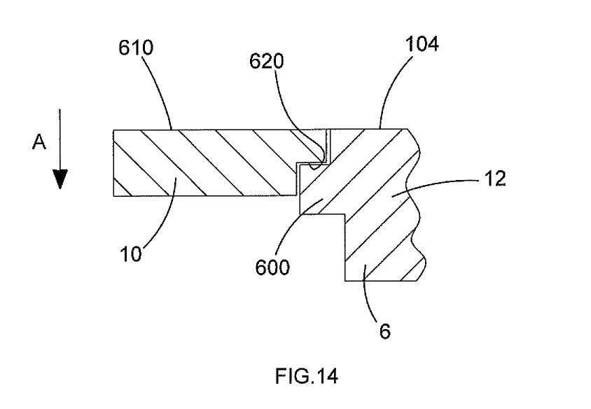

Referring to FIGS. 11-13, carrying handles 10 may be attached to the sides of the base 6. Each handle 10 may be a D-shaped handle made from plastic. A ledge 600 is preferably formed on each side of the base 6 adjacent the outer side of each platform 12. Two posts 604 are preferably formed in the base 6 on each side of each ledge 600. Each post 604 preferably has an aperture 602 with a threaded section. The threaded section can be provided using a nut 612 as shown or may be integrally formed in the wall of the aperture 602 form in the post 604.

Each handle 10 preferably has a recess 620 which has corresponding dimensions to those of the ledges 600. When attaching the handles 10 to the base 6, each handle 10 is lowered (along the direction of Arrow A) onto the base 6 from above the base 6. When each handle 10 is mounted on the base 6, each ledge 600 locates within the recess 620 of each handle 10. Two apertures 606 are preferably formed through each handle 10 in corresponding positions to the threaded apertures 602 in the base 6. Bolts 608 may be passed through the apertures 606 and screwed into the threaded apertures 602 of the posts 604 to secure each handle 10 to the base 6. The top surfaces 610 of each handle 10 are preferably flat and lie flush with the top surfaces 102, 104 of the two platforms 12 and rotatable table 100. The surfaces 610 of the handle 10 therefore extend the work surface formed by the combined surfaces 610, 102, 104 of the platforms 12 and rotatable table 100. As such, the handles 10 can remain attached while the saw is being used. The handles further help an operator in manoeuvring the saw between different locations.

A mount 27 may be pivotally mounted on the rear of the rotatable table 100 to form a bevel joint. The mount 27 can pivot about a horizontal axis relative to the rotatable table 100 to enable the saw to perform bevel cuts. Two guide rods 200 are pivotally attached to the mount 27 via a pivot joint which is described in more detail below. A cutting unit 50 is preferably slideably mounted on the two guide rods 200.

The external housing of the cutting unit 50 is preferably constructed from five clam shells 300, 302, 304, 306, 307. The first clam shell 300 forms a motor housing in which is mounted an electric motor (not shown). The first clam shell 300 may be attached to the fifth clam shell 307 using bolts. The fifth clam shell 307 preferably forms a motor mount for the electric motor. The fifth clam shell 307 preferably supports the guide mechanism for the two guide rods 200 and supports the cutting unit 50 on the guide rods 200 and which is described in more detail below. The fifth clam shell 307 may be made from aluminum which is unlike the four other clam shells 300, 302, 304, 306 which are preferably made from plastic.

The fifth clam shell 307 may be attached to the second clam shell 302 using bolts. The second and third clam shells 302, 304 are preferably attached to each other using bolts and which, in addition to the fifth clam shell 307, form a guide rod support housing, in which the two guide rods 200 are slideably mounted. The second and third clam shells 302, 304 may also form half of the fixed blade guard, which preferably surrounds the top section of a cutting blade 124 which is mounted on an output spindle 500 of the motor. The fourth clam shell 306 may be attached to the third clam shell 304 and preferably forms the second half of the fixed blade guard.

The pivot joint preferably enables the two rods 200 and the cutting unit 50 to pivot about an axis 202 relative to the mount 27 to enable the two rods 200 and the cutting unit 50 to pivot away from or towards the rotatable table 100 and extension arm 106. This enables the saw to perform chop cuts. A spring 204, which forms part of the pivot joint, biases the mount 27 and guide rods 200 to their highest position. A handle 114 may be attached to the front of the cutting unit 50 by which a user manoeuvres the cutting unit 50 relative to the base structure. The mount 27 automatically locks in its uppermost pivotal position by a latch mechanism (not shown). A pivotal lever 116 is preferably mounted on the handle 114 by which an operator can release the latch mechanism. A switch 118 may also be mounted on the handle 114, the depression of which activates the electric motor.

A fixed fence 16 is rigidly attached on top of the two platforms 12 of the base 6 at the rear of the platforms 12. The fence 16 extends across the rotatable table 100 but does not interfere with its rotational movement.

The pivot joint will now be described in more detail with reference to FIGS. 2-5. The mount 27, which is preferably manufactured from aluminum, comprises a curved wall 210 sealed at one end by an end wall 212 to form a cup shaped section 206 enclosing a tubular passage 208 of uniform circular cross section. Two walls 216, 218 may be formed around the open end cup shaped section 206 to form a groove 214. An aperture 220 is preferably formed through the center of the end wall 212.

A base 222 may be rigidly attached to the end of the two guide rods 200 to hold the two guide rods 200 in position. The base 222 preferably comprises two metal clam shells 224, 226 which are clamped around the end of the guide rods 200 and secured to each other and the guide rods using bolts 228.

One of the clam shells 224 may comprise a circular wall 230 which connects to a circular base 232 formed on the side of the clam shell 224. The size and dimensions of the circular wall 230 are such that it is capable of mating with the groove 214 of the cup shaped section 206 as best seen in FIG. 5. When the circular wall 230 is mated with the groove 214 of the cup shaped section 206, the end of the cup shape section 206 preferably abuts against circular base 232.

An elongate tube 234 preferably extends from the clam shell 224 at the center of the circular wall 230 and in parallel to the circular wall 230. When the circular wall 230 is mated with the groove 214 of the cup shaped section 206, the elongate tube 234 preferably extends into the tubular passage 208 as best seen in FIG. 5.

The pivot joint may comprise the spring 204 which has a central coiled section 234 and two straight ends 236, 238.

When the pivot joint assembled, the circular wall 230 is preferably mated with the groove 214 of the cup shaped section 206. The spring 204 is located inside of the tubular passage 208 with the coiled section surrounding the elongate tube 234. One of the straight ends 236 preferably locates within a recess 240 formed in the end wall 212 of the cup shaped section 206 to attach it to the cup shaped section 206. The other straight end 238 preferably locates in a second recess 242 formed in the clam shell 224 inside of the circular base 232 to attach it to the clam shell 224. A bolt 244 may be passed through the aperture 220 in the end wall 212 and through the elongate tube 234. The head 246 of the bolt 244 preferably locates against the outside of the end wall 212. A nut 248 and a washer 250 are preferably screwed on the free end the bolt 244 and abut against the end of the elongate tube as best seen in FIG. 5. The bolt 244 preferably secures the cup shaped section 206 to the circular wall 230 with the circular wall 230 mated with the groove 214 of the cup shaped section 206. When the bolt 244 secures the cup shaped section to the circular wall 230, the clam shell 224 in combination with the cup shaped section 206 preferably form a sealed enclosed space 208 in which the spring 204 is located. The longitudinal axis of the bolt 244 may be co-axial with the axis 202 of rotation.

The base 222 can pivot on the mount 27 about axis 202 by the circular wall 230 rotating around the groove 214 while remaining mated to it. As the base 222 pivots on the mount 27, the cup shape section 206 and/or the circular wall 230 rotates around the bolt 244. The base 222 is preferably pivotally supported on the mount 27 by the engagement of circular wall 230 and the groove 214. As the circular wall 230 rotates within the groove 214, one straight end 236 of the spring 204 rotates relative to the other end 238, storing a spring force in the coiled section 234. The spring 204 applies a biasing force between the cup shaped section 206 and the clam shell 224. The spring 204 is arranged to urge the two guide rods 200 to urge them to point upwardly and move the cutting unit 50 to its highest position. The angular movement of the base 222 on the mount 27 is limited by a projection 250 on the base 222 travelling between two end stops 252, 254 as the base 222 pivots on the mount 27. The spring 204 remains under tension regardless of the relative angular positions of the base 222 and the mount 27.

The guide mechanism for the guide rods 200 will now be described. Two brackets 502 may be formed in the top section of the fifth clam shell 307. Each bracket 502 may have straight bracket passages 504 which are tubular formed through them. The two bracket passages 504 are preferably of equal dimensions. Both bracket passages 504 may be circular in cross section along the length of the bracket passages 504 and have a constant diameter along the length of the bracket passages 504. The two bracket passages 504 are preferably aligned so that their longitudinal axes 512 are co-axial. A slide bearing 506 is preferably press fitted into and held within each of the bracket passages 504. Slide bearings are well known in the art and therefore their particular construction is not discussed in any detail. However, any suitable commercial slide bearing can be utilised.

A third bracket 508 may be formed in the lower section of the fifth clam shell 307. Third bracket 508 preferably has a straight third bracket passage 510, which is preferably tubular, formed through it. The third bracket 508, together with the third bracket passage 510, may extend the full length of the fifth clam shell 307. The third bracket passage 510 is preferably circular in cross-section along the length of the third bracket passage 504 and has a constant diameter along the length of the third bracket passage 510. The longitudinal axis 514 of the third bracket passage 510 is preferably parallel to the longitudinal axes 512 of the first two bracket passages 502.

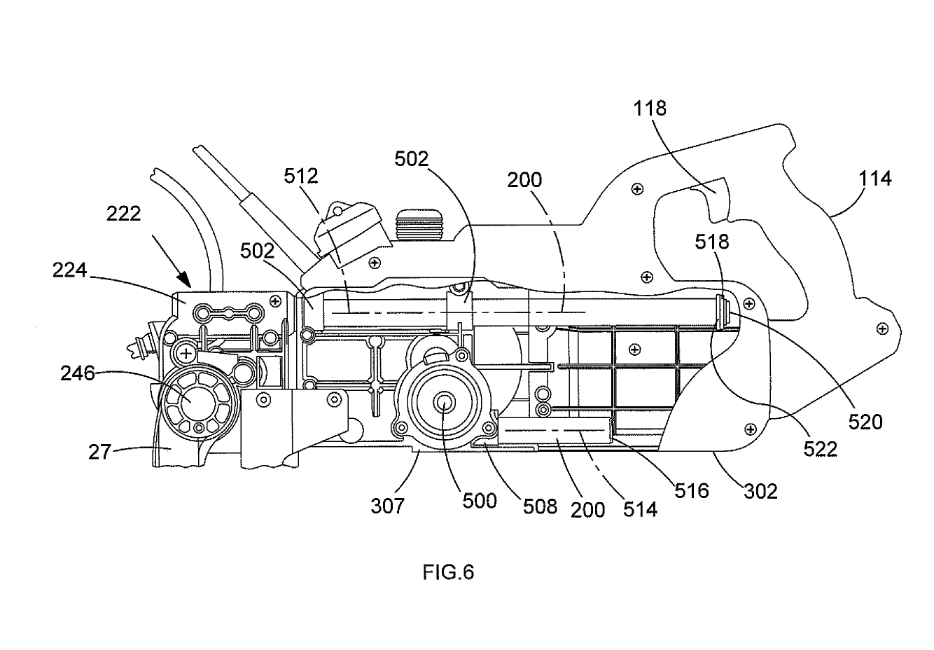

Both guide rods 200 are preferably circular in cross section and of equal uniform diameter along their lengths. The size of the outer diameter of the two guide rods 200 preferably corresponds to that of the inner diameter of the slide bearings 506 so that the upper rod 200 locates in a congruent manner within and is capable of sliding within the two slide bearings 506 as shown in FIG. 6. The longitudinal axis of the upper rod 200 is preferably co-axial with that that first two brackets passages 504. The size of the inner diameter of the third bracket passage 510 is slightly larger to that of the outer diameter of the two guide rods 200 so that the lower rod 200 locates within and is capable of being guided by the third slide bearing 508.

The weight of cutting unit 50 is preferably supported by the upper guide rod 200 and the siding movement of the cutting unit 50 is preferably controlled by the upper guide rod 200 sliding within the two slide bearings 506. The lower guide rod 200 preferably assists in guiding the cutting unit 50 as it slides along the guide rods 200 to prevent any rotational movement of the cutting unit 50 around the longitudinal axis 512 of the upper the guide rod 200.

The top guide rod 200 (as shown in FIG. 6) may be longer than the bottom guide rod 200. The end of the lower guide rod 200 is preferably sealed with a cap 516 which clips onto the end of the lower guide rod 200. A radially extending washer 518 of greater diameter than the upper guide rod 200 may be attached to the end of the upper guide rod 200 using a bolt 520. A resiliently compressible rubber ring 522 is preferably mounted on the end of the upper guide rod 200 adjacent the washer 518. The rubber ring 522 and washer 518 preferably provide an end stop to limit the amount of sliding movement of the cutting unit 50 along the two guide rods 200 away from the base 22, As the cutting unit 50 slides along the guide rods 200 away from the base, the rubber ring 522 preferably encounters the side of the bracket 502 preventing further movement as the rubber ring 522 cannot pass through the slide bearing 506 and therefore becomes sandwiched between the side of the bracket 502 and the washer 518. The rubber ring 522 preferably provides a dampener to the impact of the side of the bracket 502 engaging the end stop formed by the washer 518 and rubber ring 522 of the upper guide rod 200, preventing damage to any of the components.

As can be seen in FIG. 6, the spindle 500 of the motor preferably projects between the two guide rods 200, the motor being located on one side of the guide rods 200 and the cutting blade 124 on the other side.

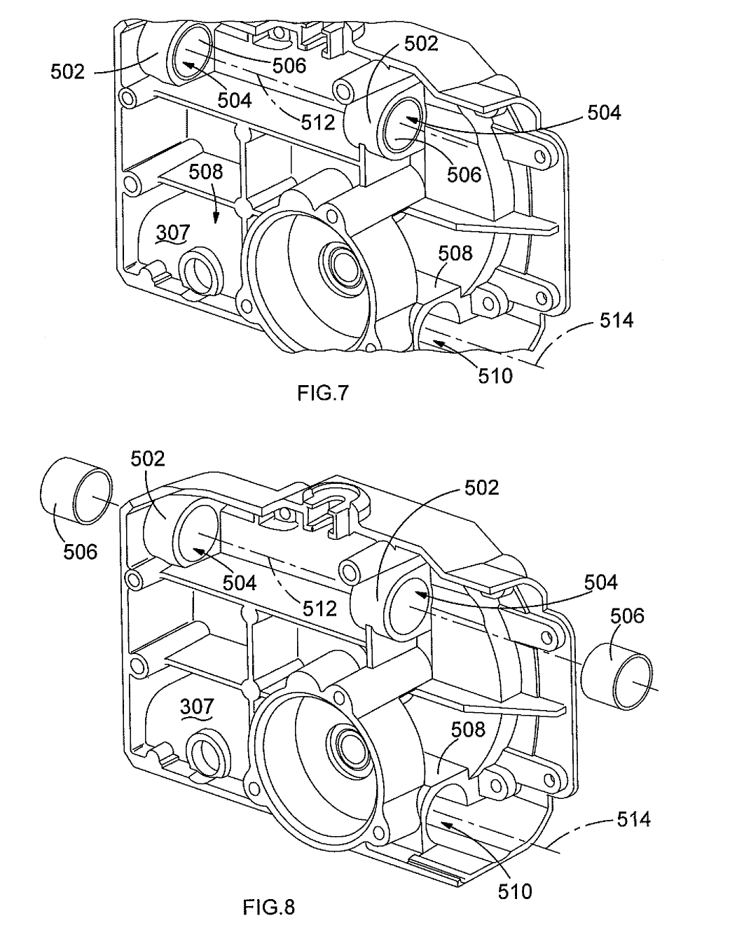

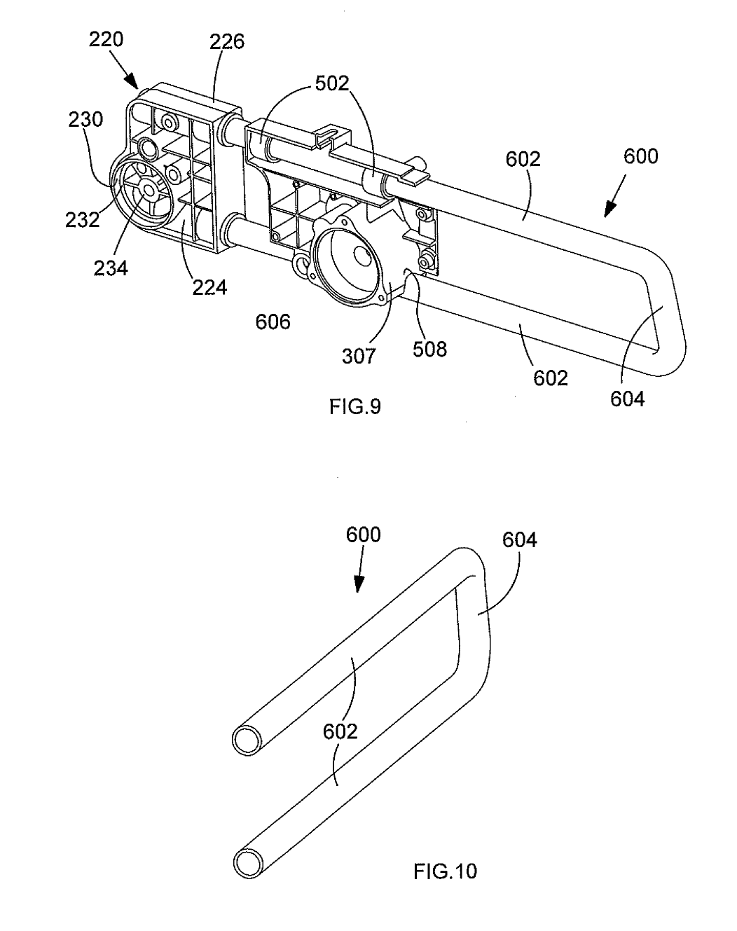

Referring to FIGS. 9 and 10, an alternative design of guide rods 200 is shown. Where the same features are used in relation to FIGS. 1 to 8 are present in FIGS. 9 and 10, the same reference numbers have been used.

The two guide rods 200 of FIGS. 1 to 8 have been replaced by a single guide rod 600 which has been bent to form a U shape having two parallel straight sides 602 joined together by a perpendicular connecting section 604. The parallel sides 602 act in the same manner as the two guide rods 200 as described previously with the cutting unit 50 sliding along the parallel sides 602. The two frees ends of the parallel straight sides 602 of the guide rod 600 are preferably rigidly clamped in the same manner in the base 222. However, as the two parallel sides 602 are connected by a connecting section 604, there is now no need for a separate end stop to limit the movement of the cutting unit 50 away from the base 222 as the connecting section 604 preferably forms an end stop which engages the cutting unit 50 when the cutting unit 50 is slid along the guide rod 600 away from the base 222. While the connecting section 604 can engage any part of the cutting unit 50 to act as an end stop, the connecting section 604 ideally engages the side of one of the brackets when acting as an end stop. Furthermore, as the length of the two parallel sides 602 are preferably the same, the length of the third bracket 508, together with the third bracket passage 510, does not need to extend the full length of the fifth clam shell 307, thus allowing a part 606 of the fifth clam shell 507 to be removed, exposing the guide rod 600. This allows less aluminum to be used in the manufacture of the fifth clam shell 307.

While the embodiment of the present invention has been described with reference to a compound sliding miter saw, it will be appreciated that the invention is applicable to any saw having a cutting unit slideably mounted on a base assembly which is capable of making sliding cuts.

1: A sliding compound miter saw comprising:
a base assembly;
a rotatable table pivotally mounted to the base assembly;
a mount pivotally mounted on the rear of the rotatable table;
a mount base pivotally mounted on the mount to enable the saw to perform chop cuts;
two parallel guide rods rigidly attached to the mount base, the guide rods extending across the base assembly, one guide rod being located above the other guide rod;
a cutting unit slideably mounted on the two guide rods;
a handle being mounted to each side of the base, the handles having top surfaces which are flat and co-planar with at least one of the base assembly and the rotatable table.

2: The miter saw of claim 1, wherein each side of the base assembly comprises a receiving section which faces at least in an upward direction;
the underside of each handle comprising a mating portion which faces at least in a downward direction for engaging with a corresponding receiving section of the base assembly;
wherein each handle is mounted on the base by being lowered from above the base assembly onto the base assembly so that the receiving section of the base assembly engages with the mating portion of the handle.

3: The miter saw of claim 2 wherein each of the receiving sections of the base assembly includes a ledge.

4: The miter saw of claim 2 wherein each of the mating portions is a recess.

5: The miter saw of claim 2 wherein each handle is secured to the base assembly with at least one bolt which passes through the handle and fastens it to the base.

6: The miter saw of claim 1 wherein each handle is a D shaped handle made from plastic.

7: A saw comprising:
a base assembly;
guide rods attached to the base;
a cutting unit slideably mounted on the guide rods;
wherein the length of one of the guide rods is longer that the length of the other guide rod.

8: The saw of claim 7 wherein the longer guide rod comprises an end stop formed on the end of the longer guide rod for engaging the cutting unit when the cutting unit is slid along the guide rods away from the base assembly.

9: The saw of claim 8 wherein the end stop comprises a radially extending washer of greater diameter than the longer guide rod, the washer being attached to end of the longer guide rod.

8: The saw of claim 7 wherein the end stop further comprises a resiliently compressible ring mounted on the longer guide rod adjacent the washer.

9: The saw of claim 8 wherein the cutting unit comprises a motor mount having a first bracket for holding a slide bearing supporting the longer guide rod, and a second bracket through which the shorter guide rod passes.

10: The saw of claim 7, wherein the two rods are manufactured from a unitary rod.

11: The saw of claim 10, wherein the unitary rod is bent to form a U-shape having two straight parallel sides joined together by a perpendicular connecting section.
